(19) United States
(12) Patent Application Publication
(10) Pub. No.: US 2021/0096446 A1
(43) Pub. Date: Apr. 1, 2021

(54) PROTRUDING STRUCTURE OF LENSES BARREL

(71) Applicant: SUN YANG OPTICS DEVELOPMENT CO., LTD., TAOYUAN CITY (TW)

(72) Inventors: SHENG-CHE WU, TAOYUAN CITY (TW); PING-TIEN WU, TAOYUAN CITY (TW); YEN-PIN TSAI, TAOYUAN CITY (TW)

(21) Appl. No.: 16/589,375

(22) Filed: Oct. 1, 2019

(51) Int. Cl. G03B 17/12; G02B 7/02

(52) U.S. Cl. CPC G03B 17/12; G02B 7/04; G02B 7/021; G02B 7/023

(57) ABSTRACT

A protruding structure of lenses barrel comprises a lenses barrel made by metal, said lenses barrel having an inner side of the barrel; and at least one protruding structure being an elastomer made by macromolecule material and arranged at said inner side of the barrel; whereby the interval between said inner side of the barrel and the predetermination is decreased into extremely small interval by the interference from the surface of said protruding structure, or produce slight interference to the predetermined installing component, the predetermined installing component can be lens, not only the protruding structure solve the lens shifting problem also achieve the effect of getting better image and improving the stability of lens installing, and coating said macromolecule material through spray coating or adhesive dripping, then solidify said macromolecule material by heating or UV Radiation to form the protruding structure, and achieve the effect of precisely controlling the thickness and range of the protruding structure.

### BACKGROUND OF THE INVENTION

### 1. Field of the Invention

The invention relates to a protruding structure of lenses barrel, especially to one that has a protruding structure which can decrease the interval between the protruding structure and predetermination, or the thickness of the protruding structure produce slight interference to predetermination.

### 2. Description of the Related Art

Lenses are highly reliable in many technical areas, such as projector lenses, car lenses, drone lenses, etc. Lenses must-have functions of vibration resistant and high or cold temperature resistant and maintain functional in a tough operating environment. To achieve these purposes, these kinds of lenses are often made by glass lens and metal lenses barrel. Compared with the plastic material, metal provides better stability. However, during the designing of the lenses structure, the inner diameter of the barrel must be bigger than the external diameter of the lens, so as to create gaps for the lens to fit into the lenses barrel. Yet, the influence of the tolerance during manufacturing is a problem, the range of gaps manufactured setting must be larger to prevent the installing problem of inconsistent size. Despite the lens can install easily, but the gap is too big to limit the shifting of the lens, then end up with bad photo quality. The present invention is for providing solutions to these problems.

### SUMMARY OF THE INVENTION

It is a primary objective of the present invention to provide a protruding structure of lenses barrel that can reduce the interval between the lens or produce slight interference to the lens to solve the problems of lens shifting in prior art, and then improve the quality of the photo and the stability of lens installing.

It is another objective of the present invention to provide a protruding structure of lenses barrel which coated with the macromolecule material by the spray coating device and the dripping device, then solidify the macromolecule material into the elastomer form by heating or UV Radiation, in order to achieve effect of precisely controlling the thickness of the protruding structure.

To achieve the above objectives, the technique used in the present invent includes a lenses barrel made by metal, said lenses barrel having an inner side of the barrel; and at least one protruding structure being an elastomer made by macromolecule material and arranged at the inner side of the barrel;

whereby the interval between said inner side of the barrel and the predetermination is decreased into extremely small interval by the interference from the surface of said protruding structure, or the thickness of said protruding structure produce slight interference to predetermination.

Furthermore, the thickness of said protruding structure is 1 um-2 um.

Moreover, the thickness of said protruding structure is 5 um-15 um or 170 um-450 um.

Yet, the inner side of the barrel has a position one, said protruding structure here is distinguished as a protruding structure one, and said protruding structure one is arranged at said position one annularly.

Yet, the inner side of the barrel has a position two, said position two is below said position one, said protruding structure here is distinguished as a protruding structure two, and said protruding structure two is arranged at said position two annularly.

Yet, the inner side of the barrel has a position three, said position three is below said position two, said protruding structure here is distinguished as a protruding structure three, and said protruding structure three is arranged at said position three annularly.

Another technique used in the present invent comprises a lenses barrel made by metal, said lenses barrel having an inner side of the barrel; and at least one protruding structure which is using spray coating device with a predetermined nozzle aperture to coat a macromolecule material on said inner side of the barrel, and by controlling a parameters of the pressure of the feeding and a parameters of the time of feeding adjust the thickness of the macromolecule material, and coat repeatedly on the different position of said inner side of the barrel, then solidify the macromolecule material into the elastomer form by heating or UV Radiation;

whereby the interval between said inner side of the barrel and the predetermination is decreased into extremely small interval by the interference from the surface of said protruding structure, or the thickness of the protruding structure produce slight interference to predetermination.

Furthermore, the viscosity of said macromolecule material is 800 cps, said nozzle aperture is 0.25 mm, said parameters of the pressure of feeding is 5-17 psi, said parameters of the time of feeding is 0.2 second, and the thickness of said protruding structure is 5 um-15 um.

Another technique used in the present invent comprises a lenses barrel made by metal, said lenses barrel having an inner side of the barrel; and at least one protruding structure which is using an adhesive dripping device with a predetermined aperture to coat said macromolecule material on said inner side of the barrel, and by controlling said parameters of the pressure of the feeding and said parameters of the time of feeding adjust the thickness of said macromolecule material, and drip repeatedly on the different position of said inner side of the barrel, then solidify said macromolecule material into the elastomer form by heating or UV Radiation;

whereby the interval between said inner side of the barrel and the predetermination is decreased into extremely small interval by the interference from the surface of said protruding structure, or the thickness of said protruding structure produce slight interference to predetermination.

Furthermore, the viscosity of said macromolecule material is 7000 cps, said aperture of said adhesive dripping device is 0.34 mm, said parameters of the pressure of feeding is 20-50 psi, said parameters of the time of feeding is 1 second, and the thickness of said protruding structure is 170 um-450 um.

To achieve the object mentioned above, at said inner side of the barrel where the lens is installed, the present invention produces said protruding structures uniformly on said lens installing part, the method of producing said protruding structures can be spray coating or adhesive dripping, then solidify said protruding structure by heating up or UV Radiation, and reduce the diameter of said lens installing part and precisely control the thickness of the protruding structure by modifying coating process; thus, when installing lens, said protruding structure produce slight interference to it. Also, said protruding structures can make sure the lens stays in the axis center or the interval between said inner side of the barrel and the predetermination is decreased into extremely small interval by the interference from the surface of said protruding structure, not only it has better stability also provide better vibration resistant and temperature resistant.

### BRIEF DESCRIPTION OF THE DRAWINGS

FIG. 1A is a schematic diagram illustrating the present invention in the first applicable embodiment.

FIG. 1B is a sectional view along line 1B-1B in FIG. 1A.

FIG. 2A is a schematic diagram illustrating the producing of the protruding structure by the spray coating device in the present invention.

FIG. 2B is a schematic diagram illustrating the producing of the protruding structure by the adhesive dripping device in the present invention.

FIG. 3A is a schematic diagram illustrating the structure of the present invention in a second applicable embodiment;

FIG. 3B is a sectional view along line 3B-3B in FIG. 3A;

FIG. 4A is a schematic diagram illustrating the structure of the present invention in a third applicable embodiment;

FIG. 4B is a sectional view along line 4B-4B in FIG. 4A;

FIG. 5A is a schematic diagram illustrating the structure of the present invention in a fourth applicable embodiment;

FIG. 5B is a sectional view along line 5B-5B in FIG. 5A;

FIG. 6A is a schematic diagram illustrating the structure of the present invention in a fifth applicable embodiment;

FIG. 6B is a sectional view along line 6B-6B in FIG. 6A;

FIG. 7 is a schematic diagram illustrating the present invention not producing slight interference to the lens;

FIG. 8 is a schematic diagram illustrating the present invention producing slight interference to the lens;

FIG. 9 is a sectional view along line 9-9 in FIG. 8; and

FIG. 10 is a schematic diagram illustrating the present invention producing slight interference to the lens or creating an extremely small interval.

### DETAILED DESCRIPTION OF THE PREFERRED EMBODIMENT

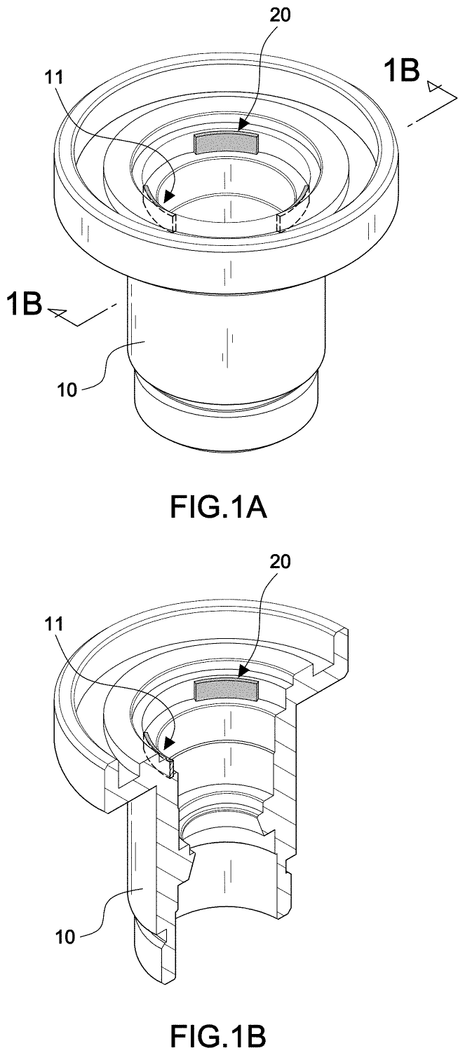

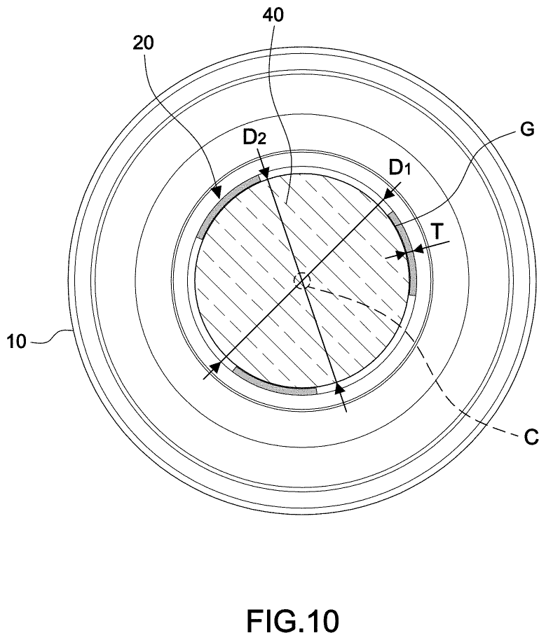

Referring to FIGS. 1A-1B and FIG. 10, in a first applicable embodiment, a protruding structure of lenses barrel mainly includes a lenses barrel 10 made by metal, said lenses barrel 10 having an inner side of the barrel 11, at least one protruding structure 20 being an elastomer made by a macromolecule material 31 and arranged at the inner side of the barrel 11;

Whereby the thickness T of protruding structure 20 has an extremely small interval G on the side of the inner side of the barrel 11, or the thickness T of protruding structure 20 produces slight interference, but the present invention is not limited to such application.

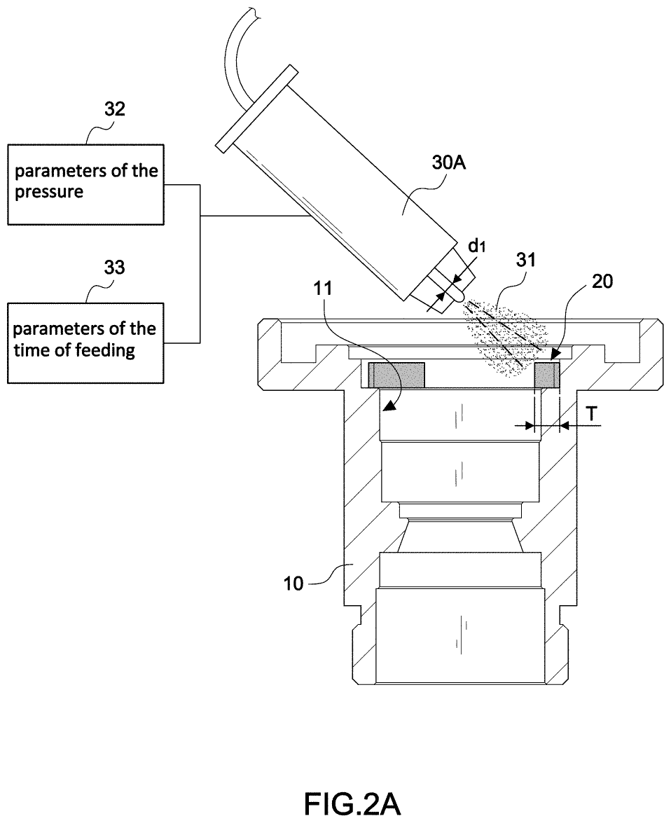

FIG. 2A illustrated a spray coating device 30A with a predetermined nozzle aperture d1 which can spray the macromolecule material 31, let the macromolecule material 31 attach to the inner side of the barrel 11, then precisely control a parameters of the pressure 32 and a parameters of the time of feeding 33 to adjust the thickness of the macromolecule material 31, then repeatedly coat the macromolecule material 31 on different position of the inner side of the barrel 11, and solidify the macromolecule material 31 by heat source or light source; in this applicable embodiment, the viscosity of the macromolecule material 31 is 800 cps, the nozzle aperture d1 is 0.25 mm, the parameters of the pressure 32 is 5-17 psi, the parameters of the time of feeding 33 is 0.2 second and the thickness T of the protruding structure is 5 um-15 uum, but the present invention is not limited to such application.

FIG. 2B illustrated an adhesive dripping device 30B with predetermined adhesive dripping device aperture d2 which can coat a macromolecule material 31, let the macromolecule material 31 attach to the inner side of the barrel 11, then precisely control a parameters of the pressure 32 and a parameters of the time of feeding 33 to adjust the thickness of the macromolecule material 31, then repeatedly coat the macromolecule material 31 on different position of the inner side of the barrel 11, and solidify the macromolecule material 31 by heat source or light source; in this applicable embodiment, the viscosity of macromolecule material 31 is 7000 cps, the adhesive dripping device aperture d2 is 0.34 mm, the parameters of the pressure 32 is 20-50 psi, the parameters of the time of feeding 33 is 1 second and the thickness T of protruding structure is 170-450 um, but the present invention is not limited to such application.

Furthermore, whereby the spray coating device 30A and the adhesive dripping device 30B let the macromolecule material 31 attach to the inner side of the barrel 11 in different positions, wherein the method of solidifying the macromolecule material 31 into protruding the structure 20 can be UV Radiation or heating, and precisely adjust the thickness T of the protruding structure 20 in 1-2 um, in this applicable embodiment the macromolecule material 31 is a curable rubber material, but the present invention is not limited to such application.

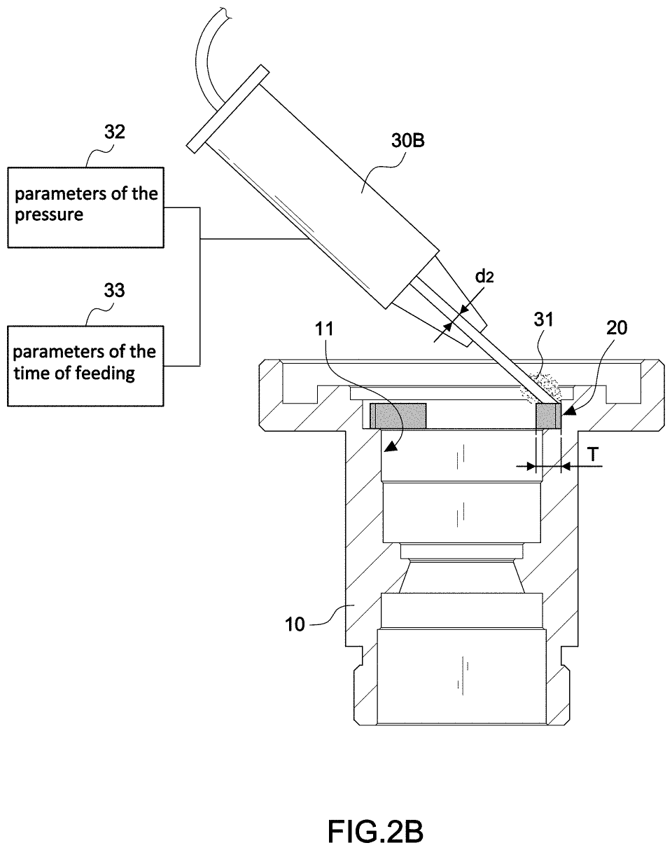

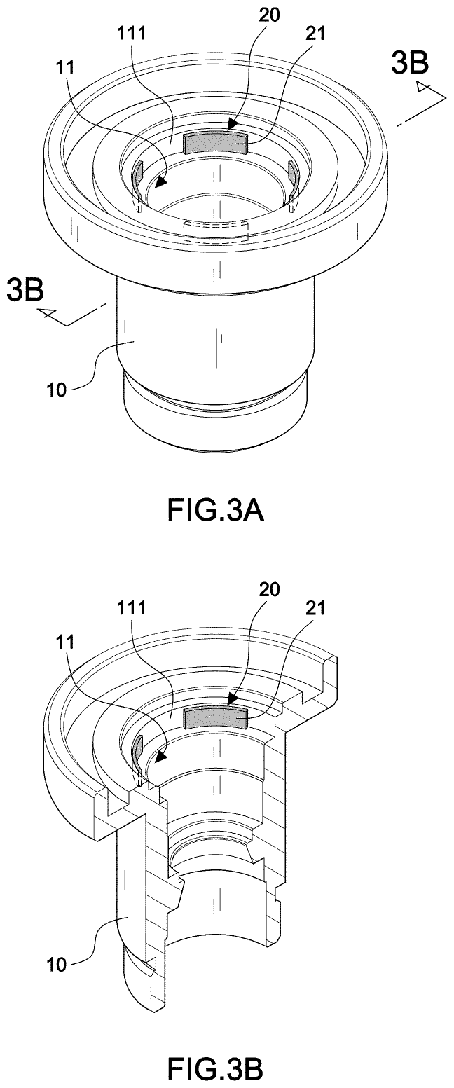

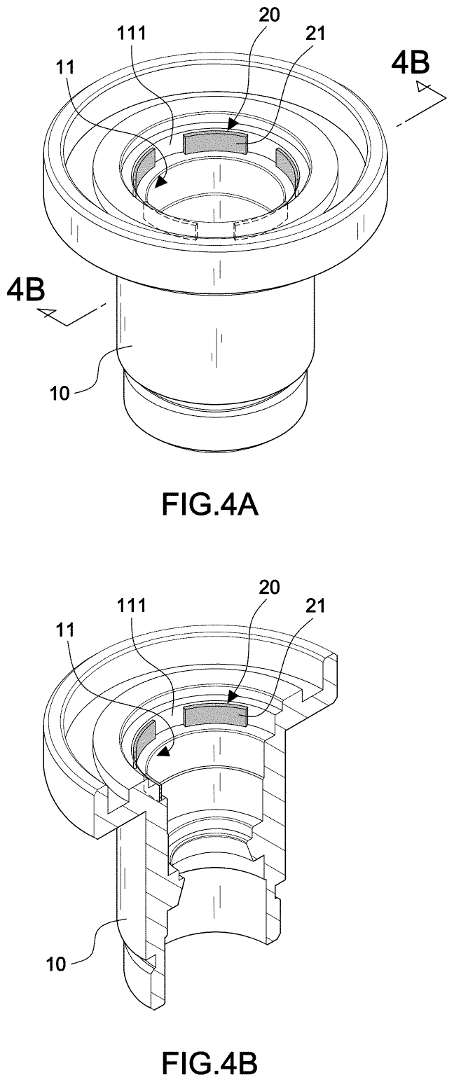

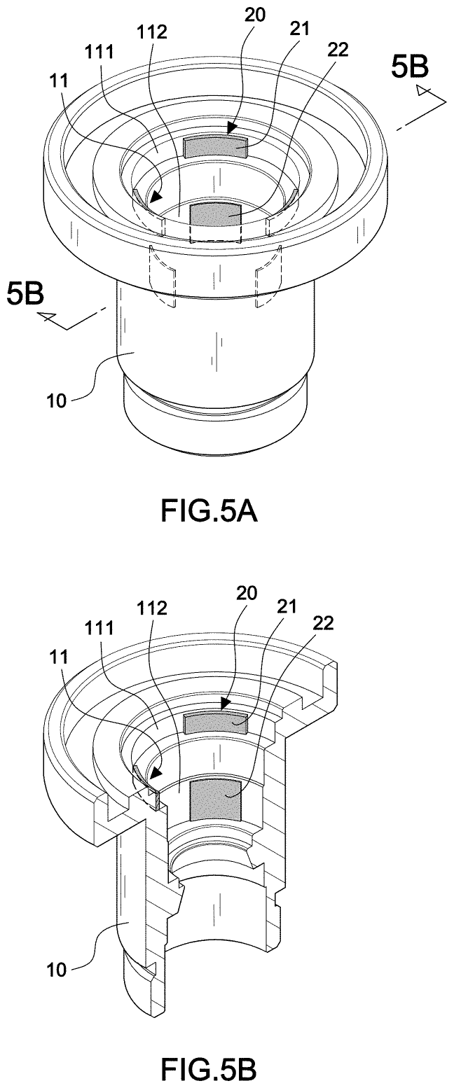

FIG. 3A, 3B, 4A, 4B illustrated the inner side of the barrel 11 comprising a position one 111, the protruding structure 20 is classified as protrusion one 21, at least three protrusion one 21 are arranged annularly at the position one 111; FIG. 5A-5B illustrated the inner side of the barrel 11 comprises a position two 112, the protruding structure 20 is classified as protrusion two 22, at least three protrusion two 22 are arranged annularly at the position two 112, FIG. 6A-6B illustrated the inner side of the barrel 11 comprises a position three 113, the protruding structure 20 is classified as protrusion three 23, at least three protrusion three 23 are arranged annularly at the position three 113, but the present invention is not limited to such application.

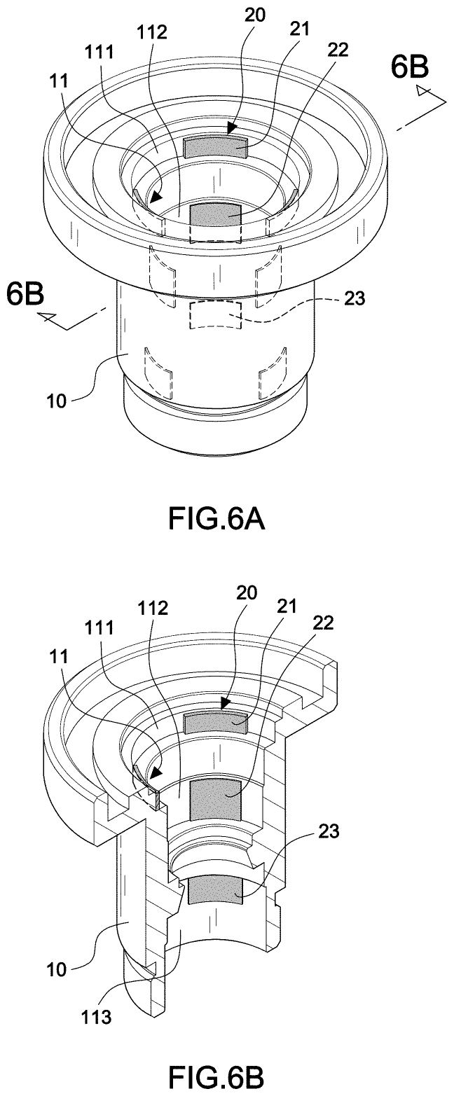

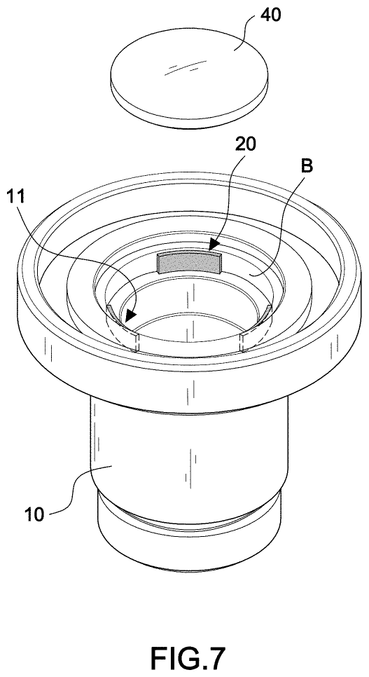

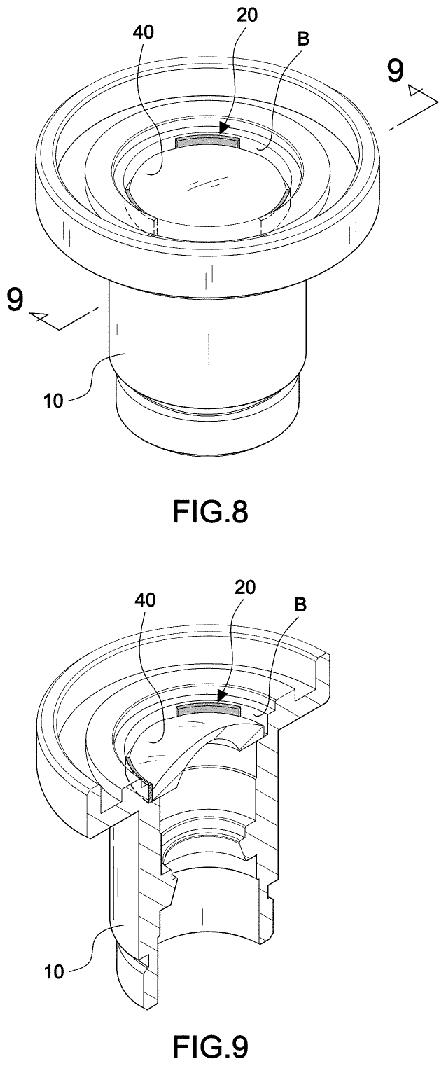

The protruding structure 20 of the present invention can decrease the interval between the predetermined installing component and the inner side od barrel or produce slight interference to the predetermined installing component, the predetermined installing component can be a lens 40, as FIG. 7 illustrated, at the lens installing place B of the inner side of the barrel 11 produce the protruding structure 20 arranged uniformly at the lens installing place B; as FIG. 8-10 illustrated, while installing the lens 40, the protruding structure 20 produce slight interference which keeping the lens 40 stay in an axis center of barrel C, the thickness T and area of the protruding structure 20 can coordinate with the thickness, weight and size of lens 40, and reduce the inner diameter D1 of the lens installing place B, therefore, the protruding structure 20 produce slight interference to the lens 40 to the axis center of barrel C or between the protruding structure 20 and the lens 40 formed the extremely small interval G, not only can solve the problems of interval between the lens barrel 10 and the lens 40, but also improved stability of installing of lens, sharpen the image and maintain best image quality during temperature change and vibration.

Furthermore, in this applicable embodiment, the internal diameter D1 of the predetermined installing place of the inside of barrel 11 is 10.58 mm and the external diameter D2 of the lens 40 is 10.56 mm, thereof the internal between them is 0.02 mm, 10 um for each side, and by spray coating or adhesive dripping attach the macromolecule material 31 to the predetermined installing place of the inside of barrel 11, there are three predetermined installing part, each of them distance 120° angular degree apart from each other, then solidify them by heating or UV Radiation, the thickness T of the protruding structure 20 is 0.005-0.015 mm, which is 5-15 um, therefore, when the parameters of the pressure 32 is 17 psi, the thickness T of the protruding structure 20 will be 15 um, or when the parameters of the pressure 32 is 8.5 psi, the thickness T of the protruding structure 20 will be 10 um, and after installing the lens 40, the protruding structure 20 produces slight interference to the lens 40, making the thickness of the extremely small interval G approach 0 and keep the lens 40 stays in the axis center of barrel C; when the parameters of the pressure 32 is 5 psi, the thickness T of the protruding structure 20 will be Sum, and after installing the lens 40, the thickness of extremely small interval G between the protruding structure 20 and the lens 40 will be Sum, making the tolerance of the distance between the lens 40 and the axis center of barrel C reduce from 10 um into Sum.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A protruding structure of lenses barrel, comprising:
a lenses barrel made by metal, said lenses barrel having an inner side of the barrel; and
at least one protruding structure being an elastomer made by macromolecule material and arranged at said inner side of the barrel;
whereby the interval between said inner side of the barrel and the predetermination is decreased into extremely small interval by the interference from the surface of said protruding structure, or the thickness of said protruding structure produce slight interference to predetermination.

2. The protruding structure of lenses barrel as claimed in claim 1,
wherein the thickness of said protruding structure is 1 um-2 um.

3. The protruding structure of lenses barrel as claimed in claim 1,
wherein the thickness of said protruding structure is 5 um-15 um or 170 um-450 um.

4. The protruding structure of lenses barrel as claimed in claim 1,
wherein said inner side of the barrel has a position one, said protruding structure here is distinguished as a protruding structure one, and said protruding structure one is arranged at said position one annularly.

5. The protruding structure of lenses barrel as claimed in claim 4,
wherein said inner side of the barrel has a position two, said position two is below said position one, said protruding structure here is distinguished as a protruding structure two, and said protruding structure two is arranged at said position two annularly.

6. The protruding structure of lenses barrel as claimed in claim 5,
wherein said inner side of the barrel has a position three, said position three is below said position two, said protruding structure here is distinguished as a protruding structure three, and said protruding structure three is arranged at said position three annularly.

7. A protruding structure of lenses barrel, comprising:
a lenses barrel made by metal, said lenses barrel having an inner side of the barrel; and
at least one protruding structure which is using a spray coating device with a predetermined nozzle aperture to coat a macromolecule material on said inner side of the barrel, and by controlling a parameters of the pressure of the feeding and a parameters of the time of feeding to adjust the thickness of said macromolecule material, and coat repeatedly on the different position of said inner side of the barrel, then solidify said macromolecule material into the elastomer form by heating or UV Radiation;
the interval between said inner side of the barrel and the predetermination is decreased into extremely small interval by the interference from the surface of said protruding structure, or the thickness of said protruding structure produce slight interference to predetermination.

8. The protruding structure of lenses barrel as claimed in claim 7,
wherein the viscosity of said macromolecule material is 800 cps, said nozzle aperture is 0.25 mm, said parameters of the pressure of feeding is 5-17 psi, said parameters of the time of feeding is 0.2 second, and the thickness of said protruding structure is 5 um-15 um.

9. A protruding structure of lenses barrel, comprising:
a lenses barrel made by metal, said lenses barrel having an inner side of the barrel; and
at least one protruding structure which is using an adhesive dripping device with a predetermined aperture to coat a macromolecule material on said inner side of the barrel, and by controlling a parameters of the pressure of the feeding and a parameters of the time of feeding adjust the thickness of said macromolecule material, and drip repeatedly on the different position of said inner of the barrel, then solidify said macromolecule material into the elastomer form by heating or UV Radiation;
the interval between said inner side of the barrel and the predetermination is decreased into extremely small interval by the interference from the surface of said protruding structure, or the thickness of said protruding structure produces slight interference to predetermination.

10. The protruding structure of lenses barrel as claimed in claim 9,
wherein the viscosity of said macromolecule material is 7000 cps, said aperture of said adhesive dripping device is 0.34 mm, said parameters of said pressure of feeding is 20-50 psi, said parameters of the time of feeding is 1 second, and the thickness of said protruding structure is 170 um-450 um.
